(19) United States
(12) Patent Application Publication
(10) Pub. No.: US 2012/0330641 A1
(43) Pub. Date: Dec. 27, 2012

(54) TRANSLATING A SYMBOLIC REPRESENTATION OF A LINGUAL PHRASE INTO A REPRESENTATION IN A DIFFERENT MEDIUM

(75) Inventors: Aaron S. Kalb, San Rafael, CA (US); Ryan P. Perry, San Francisco, CA (US); Thomas Matthieu Alsina, Mountain View, CA (US)

(73) Assignee: APPLE INC., Cupertino, CA (US)

(21) Appl. No.: 13/165,497

(22) Filed: Jun. 21, 2011

(51) Int. Cl. G06F 17/20; G06F 17/28

(52) U.S. Cl. 704/2; 704/1

(57) ABSTRACT

Translating a symbolic representation of a lingual phrase is disclosed. An internal representation that expresses output information in a namespace language used to name a plurality of output files is received. The internal representation is matched to one or more of said output files comprising data usable to provide a sensory perceptible output that communicates the output information in a target symbolic communication system.

### BACKGROUND OF THE INVENTION

Typically, when an application or other code is configured to provide audible or other prompts, or other output information, to a user in a language or other symbolic communication system other than a natural representation inside the data structures of the application or other code, a mapping between an internal representation of the output information in a native language and a corresponding translated expression of the output information in the target symbolic communication system in which it is to be rendered is required. Typically, a developer charged with providing the ability to be able to render such information in a selected one of a plurality of target symbolic communication systems, such as one of a plurality of supported spoken languages, has been required to understand applicable communication system rules of the target communication systems, such as applicable grammar and other semantic rules in the case of spoken languages. Based on such knowledge, for example, code may be written to match a prompt or other application output to one or more corresponding audio files, which are played in sequence to communicate the output information audibly in the target language, using proper grammar, correct pronunciation and intonation, etc.

### BRIEF DESCRIPTION OF THE DRAWINGS

Various embodiments of the invention are disclosed in the following detailed description and the accompanying drawings.

FIG. 1 is a block diagram illustrating an embodiment of a system configured to communicate information in a target symbolic communication system.

FIG. 2 is a block diagram illustrating an embodiment of a system configured to communicate information in a target symbolic communication system.

FIG. 3 is a block diagram illustrating an embodiment of a system configured to communicate information in a target symbolic communication system.

FIG. 4 is a flow diagram illustrating an embodiment of a process to communicate information in a target symbolic communication system.

FIG. 5 is a flow diagram illustrating an embodiment of a process to translate application information into an internal representation usable to communicate the information in a targeted language or other symbolic communication system.

FIG. 6 is a flow diagram illustrating an embodiment of a process to configure a system to translate application information into an internal representation usable to communicate the information in a targeted language or other symbolic communication system.

FIGS. 7A and 7B illustrate an example of applying an ordered set of declarative rules to generate an intermediate representation in some embodiments.

FIGS. 8A and 8B illustrate an example of applying an ordered set of declarative rules to generate an intermediate representation in some embodiments.

FIG. 9A illustrates examples of rules of transposition and inheritance in some embodiments.

FIG. 9B shows an example that illustrates application of the rules shown in FIG. 9A in an embodiment.

FIG. 10 is a flow diagram illustrating an embodiment of a process to communicate information in a target symbolic communication system via a desired medium.

FIG. 11 is a flow diagram illustrating an embodiment of a process to communicate information in a target symbolic communication system via a desired medium.

FIGS. 12A and 12B illustrate an example of matching an internal representation to one or more output data files in an embodiment.

FIGS. 12C and 12D illustrate an example of matching an internal representation to one or more output data files in an embodiment.

FIG. 13 is a flow diagram illustrating an embodiment of a process to configure a system to communicate information in a target symbolic communication system via a desired medium.

### DETAILED DESCRIPTION

The invention can be implemented in numerous ways, including as a process; an apparatus; a system; a composition of matter; a computer program product embodied on a computer readable storage medium; and/or a processor, such as a processor configured to execute instructions stored on and/or provided by a memory coupled to the processor. In this specification, these implementations, or any other form that the invention may take, may be referred to as techniques. In general, the order of the steps of disclosed processes may be altered within the scope of the invention. Unless stated otherwise, a component such as a processor or a memory described as being configured to perform a task may be implemented as a general component that is temporarily configured to perform the task at a given time or a specific component that is manufactured to perform the task. As used herein, the term ‘processor’ refers to one or more devices, circuits, and/or processing cores configured to process data, such as computer program instructions.

A detailed description of one or more embodiments of the invention is provided below along with accompanying figures that illustrate the principles of the invention. The invention is described in connection with such embodiments, but the invention is not limited to any embodiment. The scope of the invention is limited only by the claims and the invention encompasses numerous alternatives, modifications and equivalents. Numerous specific details are set forth in the following description in order to provide a thorough understanding of the invention. These details are provided for the purpose of example and the invention may be practiced according to the claims without some or all of these specific details. For the purpose of clarity, technical material that is known in the technical fields related to the invention has not been described in detail so that the invention is not unnecessarily obscured.

Providing output information in a form that enables the information to be communicated in a target symbolic communication system, such as a target spoken human language, is disclosed. In various embodiments, an internal representation that expresses application prompts or other output information in a manner that embodies applicable communication system rules of a target symbolic communication system in which the information is to be communicated is generated. An output information received from an application is parsed to identify informational elements. Rules comprising an ordered set of rules are applied to the elements, as applicable, to generate an internal representation of the information that expresses the information in a manner that reflects applicable communication system rules of the target symbolic communication system in which the information is to be communicated, for example in the form of audible words in a target spoken language.

### Application Prompts and Other Information to be Communicated

Applications, mobile devices and system, consumer electronics, and other devices may be configured to provide prompts or other output information to a user. Such information may be desired to be communicated in a target symbolic communication system and potentially via a target medium, such as audio output that communicates the information in a target spoken language, are audio or other prompts to be provided to an application and/or system user. An application and/or device may be configured to provide the information as output in response to an event or other trigger. Typically, such information is provided in a machine usable form intelligible in the first instance to a receiving component, such as binary data corresponding to a string of characters according to an encoding scheme. To be rendered as output in a target symbolic communication system, such as a spoken human language, such information must be mapped to a set of one or more media files, which can be played or otherwise rendered in sequence to communicate the information, for example audibly in a spoken language the user understands.

For example, an application or system may be configured to provide to a user prompts that reflect information associated with the user's interaction with an application and/or system. The Nike™+iPod™ offerings, for example, include products and software that enable a user to configure their iPod™ or iPhone™ to receive sensor information, for example from a workout machine or a sensor installed in their athletic shoe, and/or GPS or other data from the mobile device, and to use such information to monitor the user's progress in the course of a workout or other activity. The user may receive, for example, prompts or other information indicating an amount of time they have been exercising, how far they've run, their pace, calories calculated to have been burned, and prompts reflecting milestones such as the halfway point of a run or a timed activity and/or prompts toward the end of a workout indicating time or distance left to go.

### System Overview

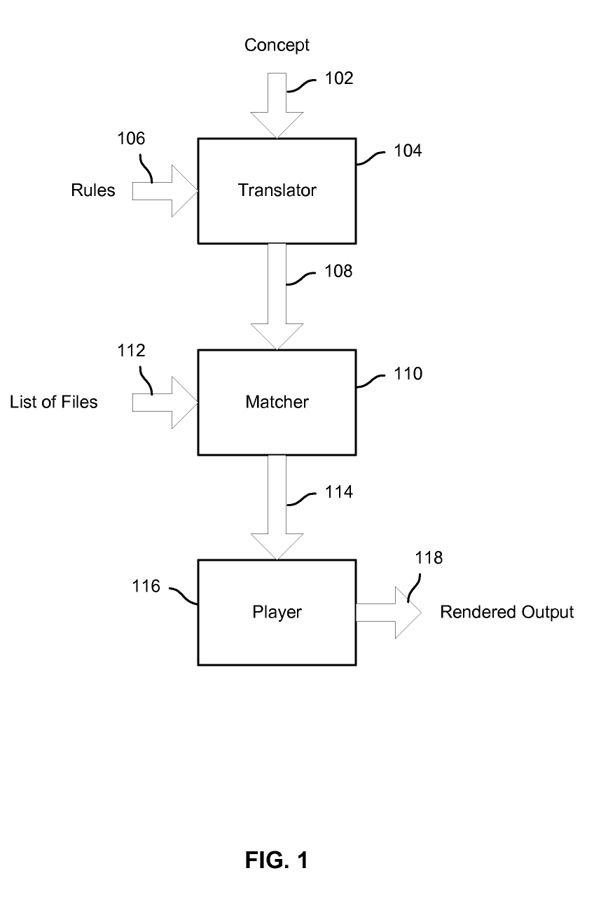

FIG. 1 is a block diagram illustrating an embodiment of a system configured to communicate information in a target symbolic communication system. In the example shown, information 102 is received by a translator 104 configured to apply an ordered set of declarative rules 106 to generate an internal representation 108 of the information 102. In some embodiments, the internal representation 108 embodies applicable rules of a target symbolic communication system, such as a target human language, in which the information 102 is to be communicated. For example, in various embodiments the internal representation 108 embodies communication system rules such as those governing the order of words in a sentence or fragment thereof; how grammatical number is expressed, such as plural versus singular; gender of nouns and modifiers thereof; conjugation of verbs; selection from among a plurality of tones that may correspond to a character, syllable, word, or other linguistic unit; etc.

In some embodiments, the internal representation 108 uses words or other linguistic units of a first language to express the information, but in an order and/or joined by connectors, etc. in a manner that reflects one or more syntactic rules of the target language or other communication system.

The internal representation 108 is provided to a matcher 110. The matcher 110 is configured to compare the internal representation 108 and/or portions thereof to filenames of files (or other objects) 112 to find one or more “best fit” files. In some embodiments, the “best fit” files are those that match the largest portion of the information as expressed in internal representation 108. The matched files 114 are rendered by player 116 to communicate the information as rendered output 118, for example, spoken words in a target language.

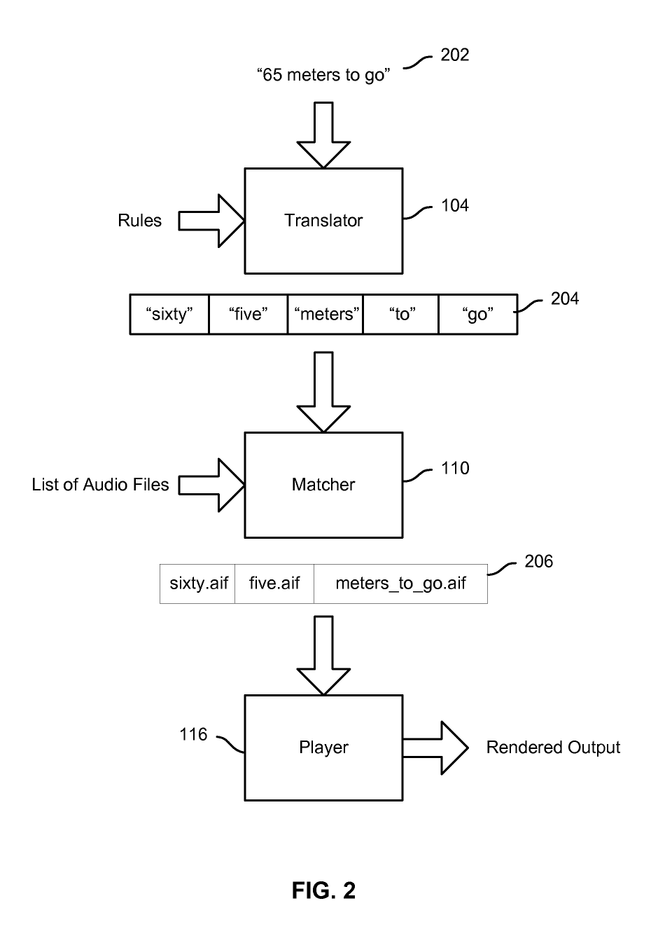

FIG. 2 is a block diagram illustrating an embodiment of a system configured to communicate information in a target symbolic communication system. In the example shown, the information to be communicated is that the user has “65 meters to go” (202) before reaching some milestone, such as the end of a run of a desired distance. The translator 104 in this example has provided the internal representation 204, in which the information has been parsed into informational elements (quantity=65, units=meters, significance=“to go”) and an ordered set of rules has been applied to the informational elements to generate the internal representation 204 as shown. In this example the target symbolic communication system is spoken English, and the internal representation 204 in the example shown uses English words to express the elements comprising the information in a manner that conforms to the semantic and grammatical rules of spoken English, for example, quantity greater than one requires the plural “meters”, quantity precedes units, etc.

The internal representation 204 is provided to matcher 110, which executes a generic (i.e., target language agnostic) matching algorithm to find a set of audio files 206 that best matches the internal representation 204. In the example shown, the matched files 206 comprise three audio files (.aif), storing respectively for example audio data created by having a voice actor speak the word “sixty”, the word “five”, and phrase “meters to go”, respectively. The player 116 uses the matched audio files to render the information as output, in this case the spoken English phrase “sixty five meters to go”.

In some embodiments, a number of output files, such as audio files, to which a source word, number, or other linguistic unit is mapped may vary depending on the target language. For example, in English the number “21” may be mapped in various embodiments to two files (a first to render spoken “twenty” and a second to render spoken “one”) or, for example to achieve greater fluency, to a single file (e.g., spoken “twenty one”). In other languages, however, more or fewer files may be required. For example, in German, the correct syntax (expressed in English) would be “one and twenty”, in Japanese it would be “two ten one”, while in Italian it would be a single word in which major parts of the separate words for “twenty” and “one” are compressed into the single word “ventuno”. Therefore, in various embodiments application output, such as the number “21” are first parsed to identify informational elements (here the number “21”) to which a target language (or language family) associated set of rules are applied to generate an internal representation that embodies syntactic rules of the target language in a manner that enables the generic matcher to find the most correct audio files to be used to express the information, as described more fully below.

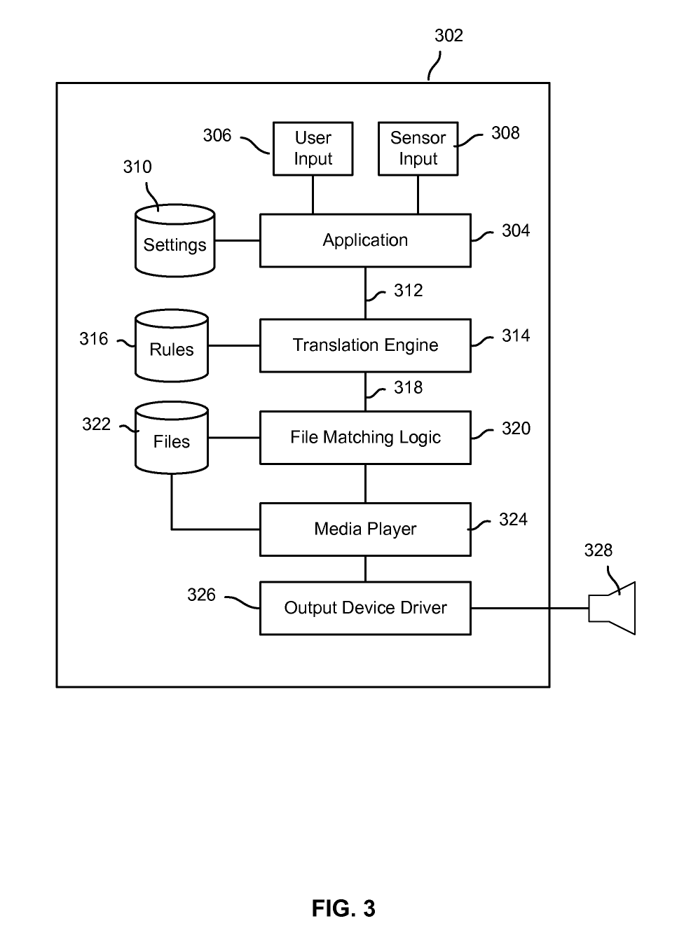

FIG. 3 is a block diagram illustrating an embodiment of a system configured to communicate information in a target symbolic communication system. In the example shown, a mobile or other computing device 302 has an application 304 running on it. For example, the application 304 may be running in a runtime or other environment provided by an operating system of the device 302. The application 304 in this example is configured to receive user input 306, for example via a hard or soft button, touch screen, wired or wireless connected input device, spoken commands, and/or one or more other input devices and/or interfaces. The application 304 in this example is configured to receive sensor input 308, for example from an external sensor such as those described above in connection with the Nike™+iPod™ example or internal sensors and/or other sources of information, such as GPS information. In addition, the application is configured at least in part by settings 310. One such setting, for example, may indicate a target language or other symbolic communication system in which application prompts are to be communicated. The application 304 provides prompts (or other information to be communicated) 312 to a translation engine 314. In some embodiments, translation engine 314 comprises a rule engine and associated logic configured to apply an ordered set of declarative rules 316 to received application information 312 to generate an internal representation 318 of the information 312. The internal representation 318 is provided to a file matching logic 320 configured to use a list of filenames of media (or other) files stored in a file store 322 to find one or more files that best match the received internal representation 318. The matched files are rendered by media player 324 via an output device driver 326 and output device 328, such as a speaker, ear buds, or other audio output device.

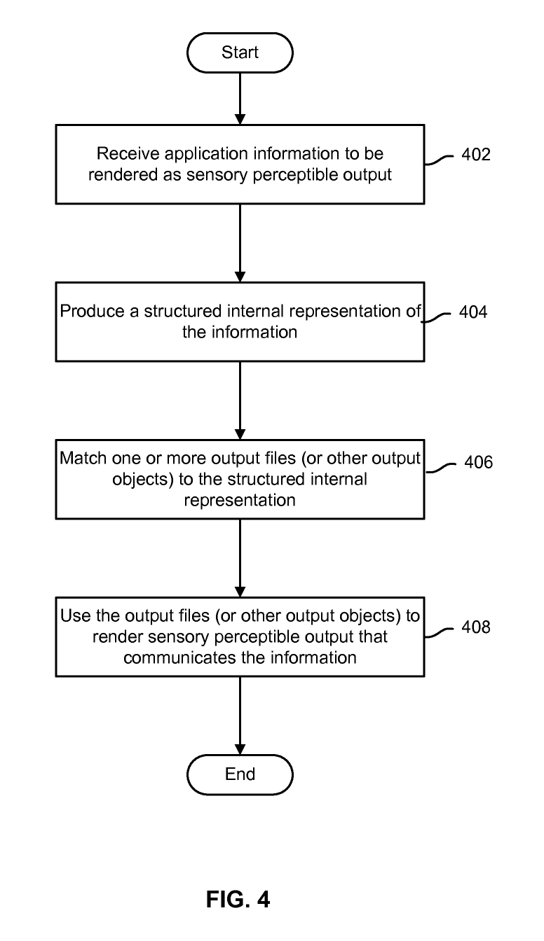

FIG. 4 is a flow diagram illustrating an embodiment of a process to communicate information in a target symbolic communication system. In the example shown, application information that is to be rendered as sensory perceptible output is received (402). A structured internal representation of the information is produced (404). One or more output files (or other objects) are matched to the structured internal representation (406). The matched output files are rendered to produce a sensory perceptible output that communicates the information (408).

### Determining What is to be Communicated

In various embodiments, an ordered set of declarative rules is applied to translate an application or other information into a form that enables the information to be communicated, via automated processing and without human intervention, in a target language or other symbolic communication system.

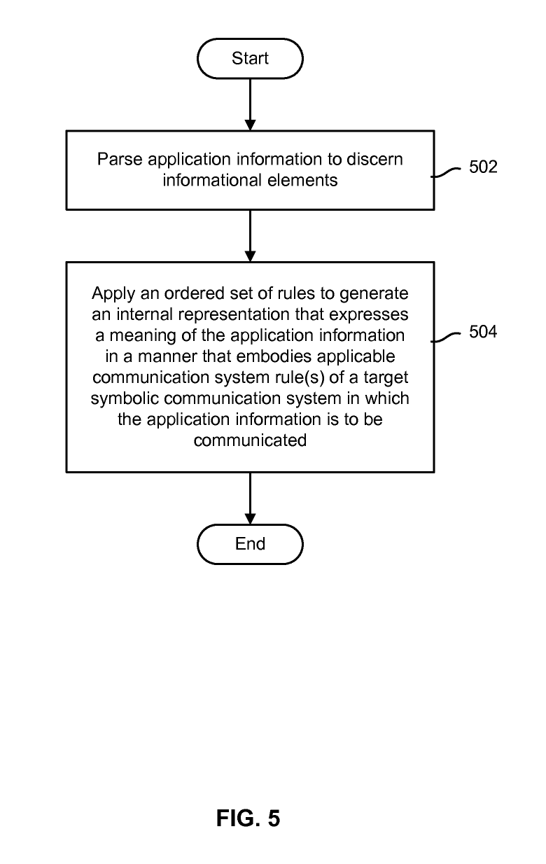

FIG. 5 is a flow diagram illustrating an embodiment of a process to translate application information into an internal representation usable to communicate the information in a targeted language or other symbolic communication system. In various embodiments, the process of FIG. 5 is used to implement 404 of FIG. 4. In the example shown, application information that is to be communicated is parsed to discern one or more informational elements (502). An ordered set of declarative rules is applied to generate based on the informational elements an internal representation that expresses the information to be communicated in a manner that embodies applicable communicate system rules of a target symbolic communication system in which the information is to be communicated (504).

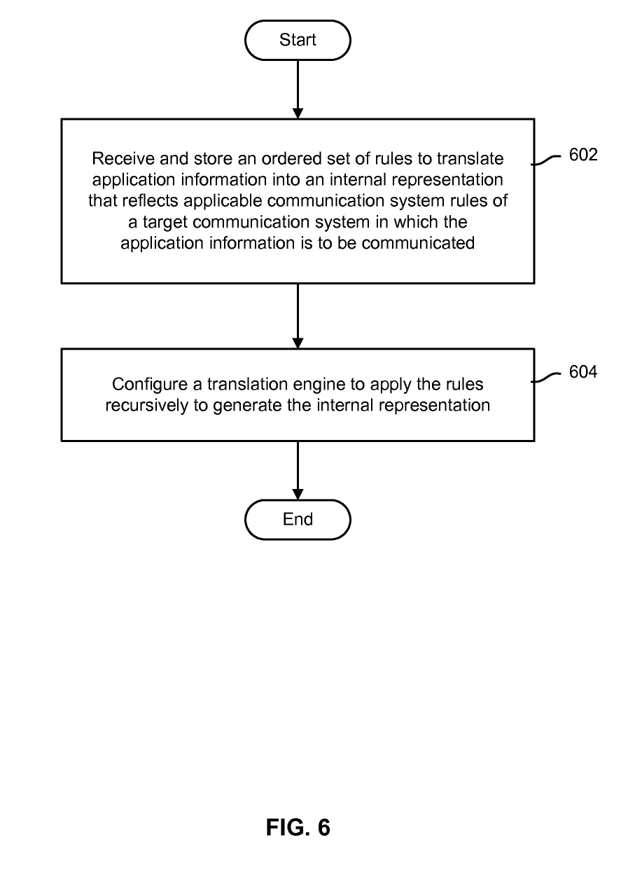

FIG. 6 is a flow diagram illustrating an embodiment of a process to configure a system to translate application information into an internal representation usable to communicate the information in a targeted language or other symbolic communication system. In the example shown, an ordered set of declarative rules is received and stored (602). The rules in some embodiments are included in a .plist or other file using an appropriate syntax, language, and/or protocol supported by the destination device. The rules are constructed and ordered based on communication system rules of a target symbolic communication system with which they are associated. In some embodiments, a separate rule set may be defined for each of a plurality of target symbolic communication systems. In some embodiments, rules sets and/or portions thereof may overlap and/or otherwise be shared among rule sets associated with multiple different target communication systems. For example, for spoken languages that share certain semantic or other rules and/or classes of rule the system may be configured to use the same .plist or portion thereof to apply those rules. The rules are constructed to be used to translate application or other output information to generate an internal representation that reflects applicable communication system rules of an associated target communication system in which the information is to be communicated.

Examples of rules received at (602) include rules of substitution (e.g., replace the number “3” with the word “three” in specified contexts), rules of transposition (e.g., in general move adjective to follow noun when translating from English to Spanish), and rules of inheritance (e.g., in some languages an adjective typically inherits grammatical number and gender from a noun the adjective modifies).

A translation engine is configured to apply the rules, recursively and in order, to generate an internal representation (604).

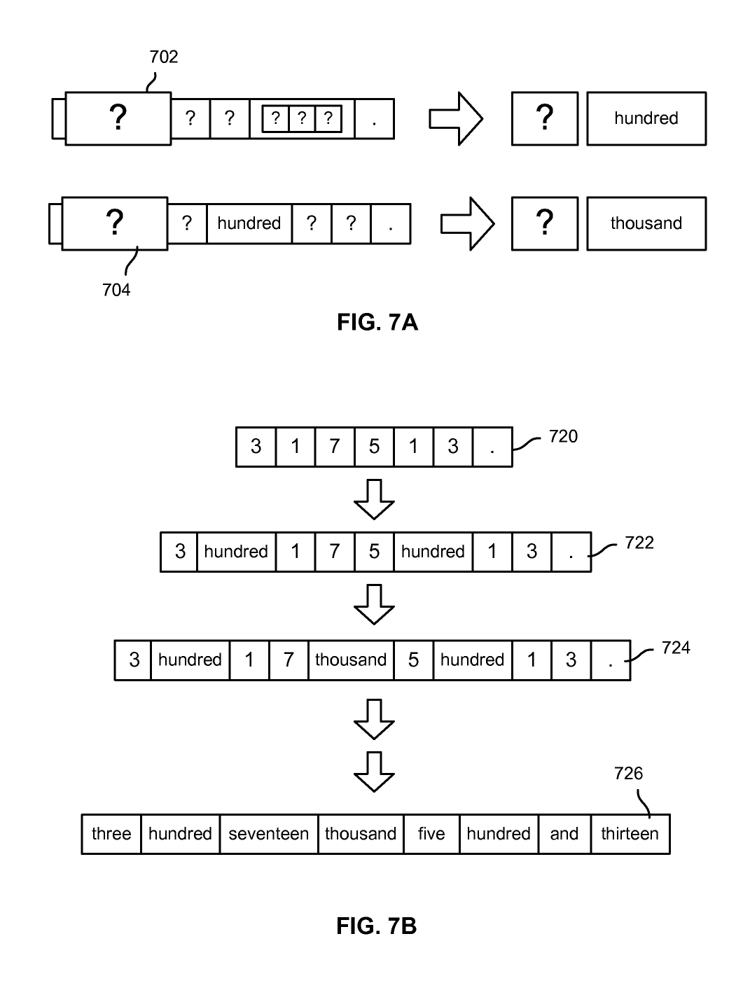

FIGS. 7A and 7B illustrate an example of applying an ordered set of declarative rules to generate an intermediate representation in some embodiments. FIG. 7A shows a first declarative rule 702 and a second declarative rule 704. Rule 702 defines a pattern that if matched results in an indicated value comprising the information and/or an intermediate representation thereof to be replaced by the same value followed by the place value identifier “hundred”. In this case, if a non-zero number followed by two digits preceding zero or more sets of three digits before a decimal point is encountered, the number is replaced by the number followed by the place identifier “hundred”. Rule 704 defines a pattern that if matched results in an indicated value comprising the information and/or an intermediate representation thereof to be replaced by the same value followed by the place value identifier “thousand”. Specifically, if a non-zero number followed by a single digit, the place value identifier “hundred” and two more digits immediately before a decimal point is encountered, the number is replaced by the number followed by the place identifier “thousand”.

In some alternative embodiments, place value identifiers such as “hundred” and “thousand” are not inserted as separate segments, as shown in FIGS. 7A and 7B, but are instead added as post-context tags appended to the number they modify, such as the number “five” or the first occurrence of the number “three” in the example shown in FIGS. 7A and 7B. In some embodiments, using the post-context tag approach to represent place value identifiers facilitates rule creation, because simpler and/or more intuitive rules can be defined due to the fact that application of one rule, such as the “hundreds” rule described above, does not affect and have to be anticipated by other rules, such as the “thousands” rule described above.

FIG. 7B shows an example of application of the rules in FIG. 7A to the application information “317513” (720). Application of rule 702 results in substitutions that yield the intermediate representation 722. Application of rule 704 to intermediate representation 722 in turn yields intermediate representation 724. In this example, note that the condition (left side as shown) of rule 704 would not have been met if rule 702 had not already been applied. The rules in this example have been constructed and ordered to efficiently yield the desired result. Note also that if the rules had been in the opposite order, with rule 704 appear first in the rule set, in a first iteration through the rules rule 704 would not have been triggered. In some embodiments, the translator or other entity applying translation rules iterates recursively through the rule set until no applicable rule is found. In such an embodiment, if the order of rules 702 and 704 were reversed, in the first pass through rule 704 would not have been triggered but rule 702 would have been triggered and enforced. In a subsequent pass, once rule 702 had been applied, rule 704 would have been triggered and applied, yielding the same end result. In the example shown, other rules not shown in FIGS. 7A and 7B have been applied to yield a final internal representation 726, for example, rules to replace the digits “1-7” and “1-3” with the words “seventeen” and “thirteen”, respectively.

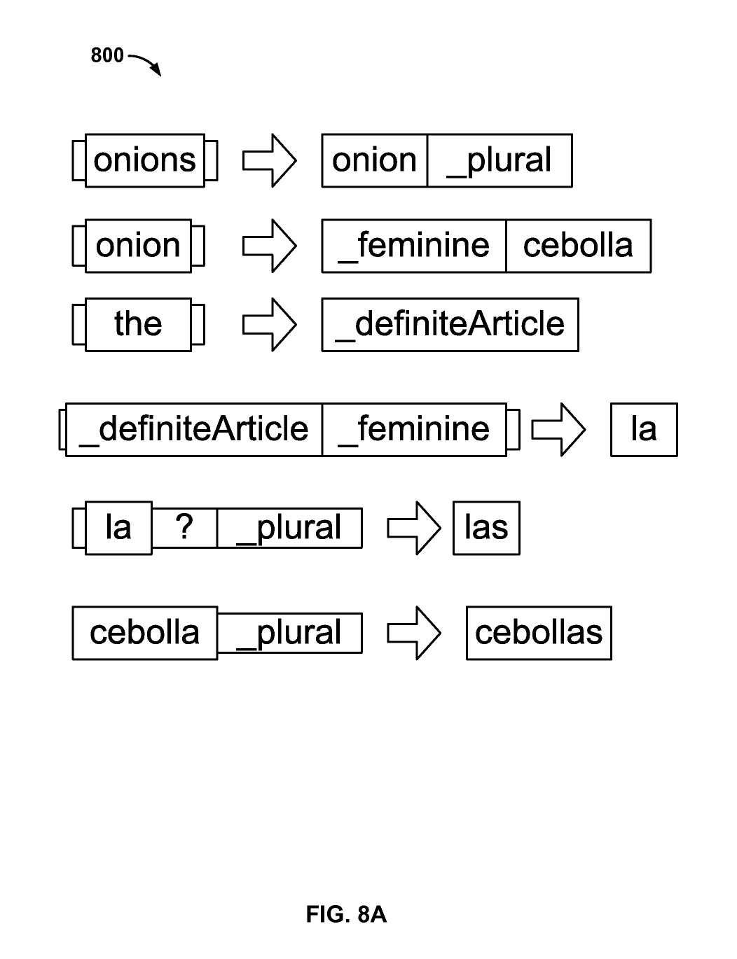

FIGS. 8A and 8B illustrate an example of applying an ordered set of declarative rules to generate an intermediate representation in some embodiments. In this example, referring to FIG. 8A a set of declarative rules 800 includes rules of substitution constructed to translate into Spanish information received originally (or transformed in an intermediate operation into) English. The rules shown in FIG. 8A may comprise an applicable subset of a broader set of rules, the other members of which are not shown for purposes of simplicity and clarity, and which other rules would not be triggered in the example shown in FIG. 8B, for example. As shown in FIG. 8B, in this example a series of translations 820 are performed by applying rules 800 in order to an original (or intermediate) representation of the information “the onions” 822. The rules 800 are applied sequentially and in order, for each rule substituting the expression on the left side as shown with the replacement expression on the right side, to yield in the end the translated internal representation 824, i.e., the expression “las cebollas”, which is how one communicates the concept of a plurality of onions in Spanish.

In the example shown in FIGS. 8A and 8B the internal representation 824 that is shown as being generated include linguistic elements, specifically words, in the target language. In other embodiments, the internal representation may comprise words or other linguistic elements in an original language of the application, for example, or some other language other than the target language. For example, the internal representation “[_definiteArticle_feminine_plural] [onion_feminine_plural]” may be generated in some embodiments, expressing the information and associated meta-information in English but to be matched in some embodiments to filenames in English of audio files comprising data to render the spoken Spanish words “las” (the feminine plural definite article in Spanish) and “cebollas” (the plural of “onions”, which is a feminine noun in Spanish). In some embodiments, use of a common namespace language to express the information to be communicated and associated meta-information, such as communication system rules or meta-information relevant to such rules, for files associated with a plurality of target languages or other communication systems one or more of which may be different from the namespace language, facilitates use of a relative simple and target language/system agnostic matcher to identify output files that match the internal representation and can be used to render the information in the target communication system and medium.

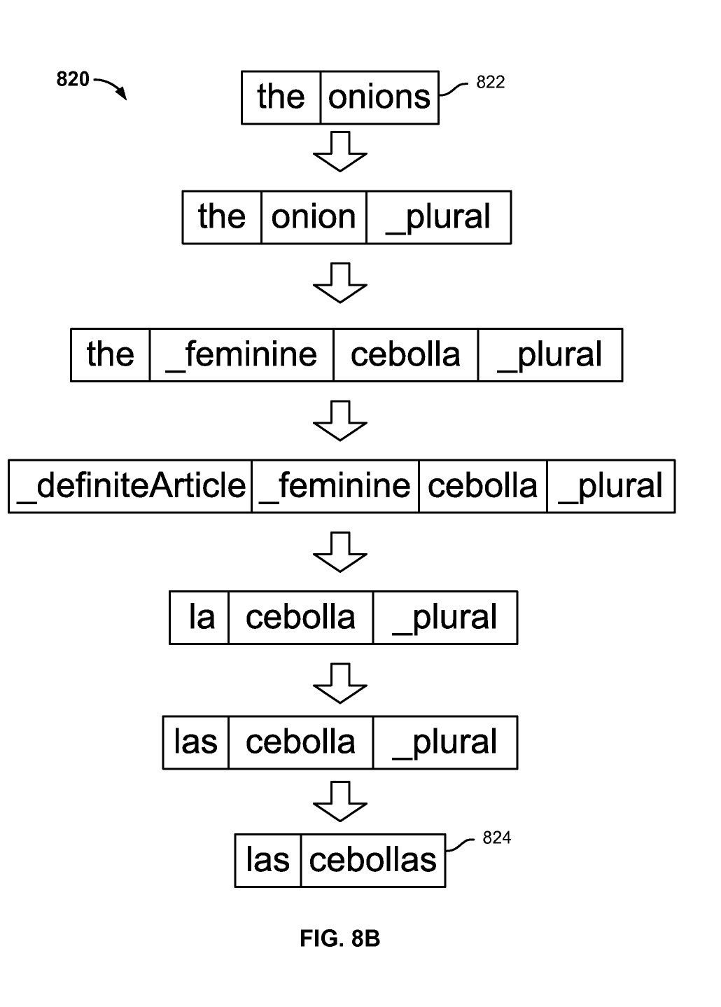

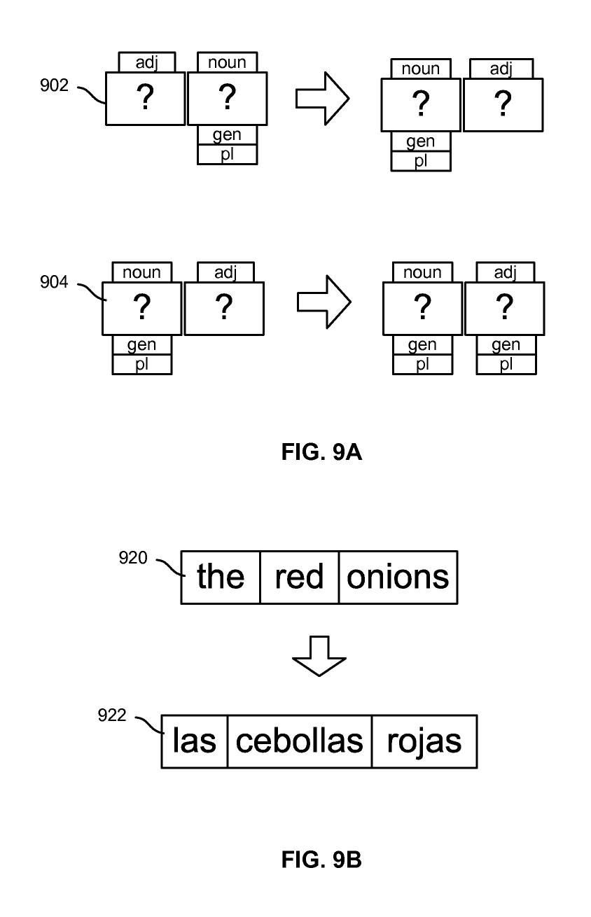

FIG. 9A illustrates examples of rules of transposition and inheritance in some embodiments. In the example shown, rule 902 provides on the left side as shown that if an adjective immediately preceding a noun that the adjective modifies is encountered, the adjective should be moved to a position immediately following the noun, as is done when translating from English to Spanish for example. Rule 904 provides that if a noun that has gender and grammatical number attributes is followed by an adjective that does not (yet) have such attributes, the adjective inherits the attribute values from the noun that precedes it.

FIG. 9B shows an example that illustrates application of the rules shown in FIG. 9A in an embodiment. A starting representation 920 in English, the words “the red onions” results in the example shown in the representation 922 comprising the Spanish words “las cebollas rojas”, in which the feminine plural form of the adjective “red” (“rojas”) appears following the noun it modifies (“cebollas” or “onions”). In a system in which the internal representation is in a common language, such as English, but embodies communication system rules of the target language, even if the target language is not English, the internal representation might look more like [the_feminine_plural] [onion_feminine_plural] [red_feminine_plural].

### Determining How to Communicate the Information

In various embodiments, an internal representation of an information to be communicated is received and matched to one or more output data files usable to communicate the information in a target symbolic communication system (for example, a target spoken language) via a desired medium (e.g., audio output).

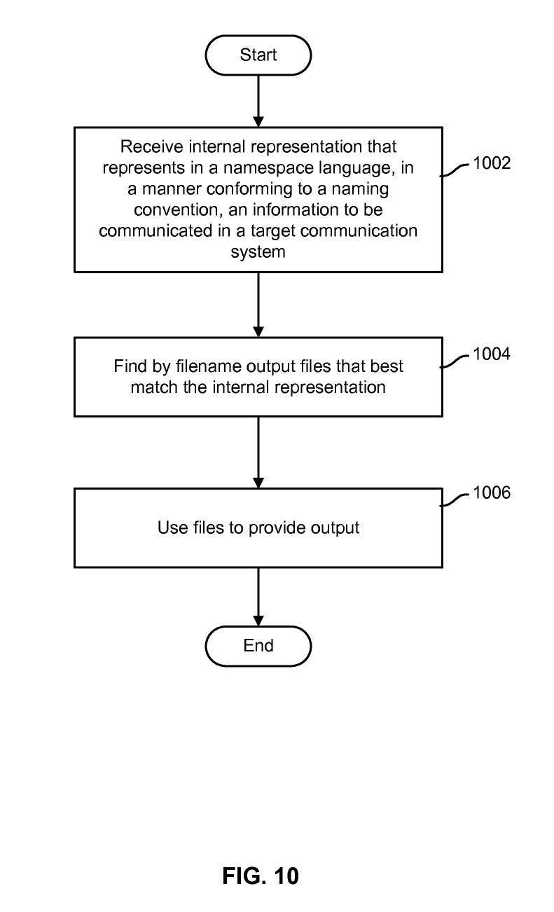

FIG. 10 is a flow diagram illustrating an embodiment of a process to communicate information in a target symbolic communication system via a desired medium. In the example shown, an internal representation that expresses, in a common output file namespace language, information to be communicated in a target language, is received (1002). The internal representation is used to find by filename one or more output files that best match the internal representation (1004). The matched files are rendered to communicate the information (1006).

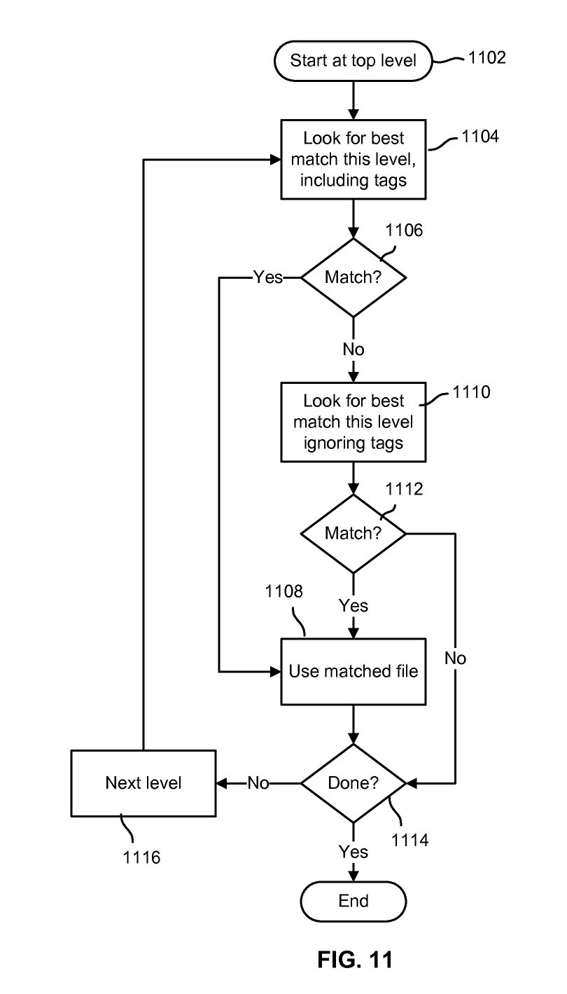

FIG. 11 is a flow diagram illustrating an embodiment of a process to communicate information in a target symbolic communication system via a desired medium. In some embodiments, the process of FIG. 11 is used to implement 1004 of FIG. 10. In the example shown, a modified “largest match” approach is implemented. Specifically, at each level starting with a top level (i.e., looking for a single file name that matches the entire internal representation), the matcher first looks for a file that is an exact match of the information and meta-information at that level. If no match is found, before descending to the next level of possible match the matcher checks to see if there is a match if one or more elements of meta-information, e.g., one or more meta-information tags, are ignored. For example, files that include complete phrases may not include in their name meta-information such as gender for each or even any words included in the phrase, since such meta-information would not in the case of use of such a file be required to also match correctly corresponding files for definite articles, adjectives, and other modifiers. Referring to FIG. 11, the process starts at a top level (1102) and looks for a match at that level (1104). If a file matching the entire internal representation is found (1106), that file is used (1108) and the process ends (1114). If not (1106), a match is sought at the same level but ignoring for the moment at least certain meta-information, such as grammatical number and/or gender tags (1110). If a match is found it is used (1108), otherwise the match process descends to a next level down (1116) and a match (for both information and associated meta-information) is sought at that level (1114). For example, if the internal representation has three elements and no match for the entire internal representation is found, a file name matching any two adjacent elements is sought. The process of FIG. 11 continues until files matching all elements comprising the internal representation have been found.

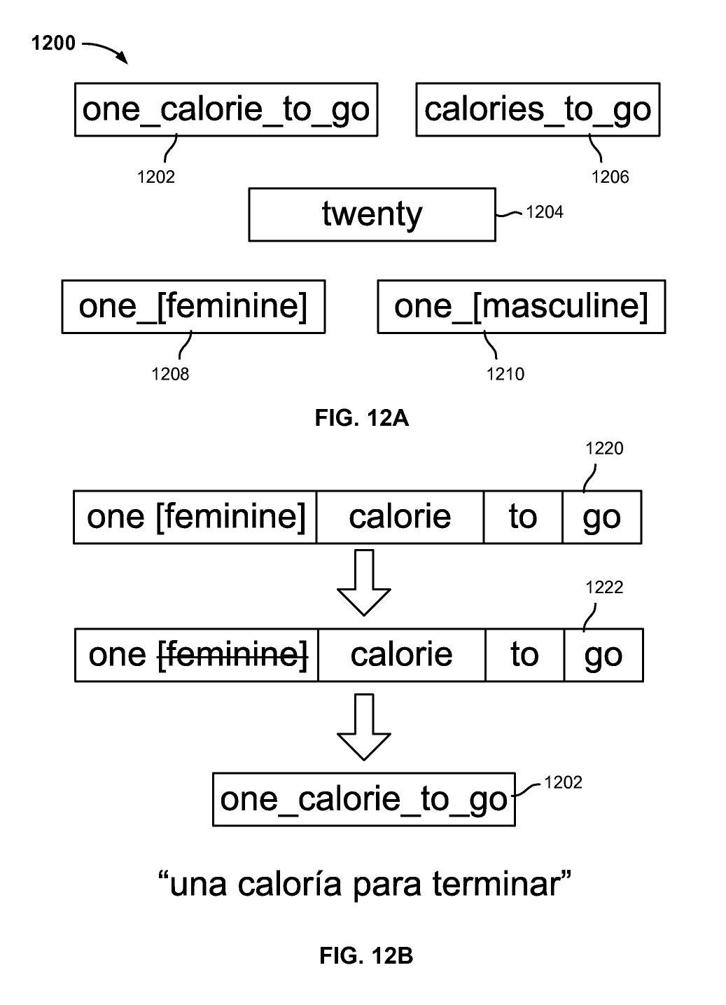

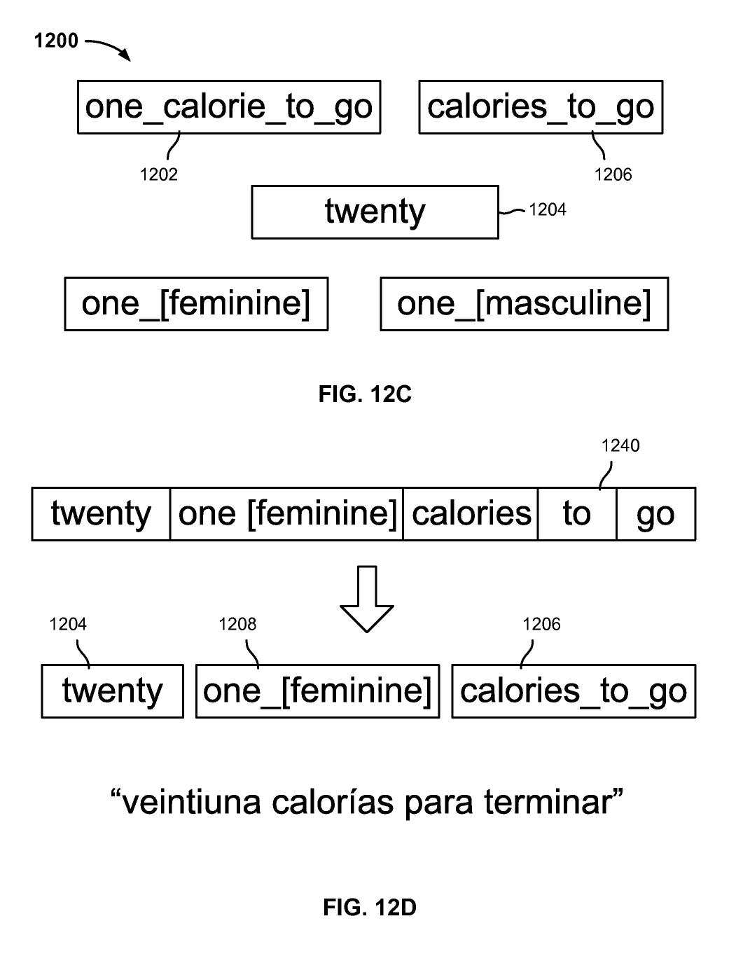

FIGS. 12A and 12B illustrate an example of matching an internal representation to one or more output data files in an embodiment. In the example shown, a set of output files 1200 includes audio files 1202, 1204, 1206, 1208, and 1210 as shown. Referring to FIG. 12B, the internal representation 1220 is first checked at a top level (entire representation) to seek a match. Since no file named “one_feminine_calorie_to_go” is found, the gender tag “feminine” is ignored temporarily to continue processing at the current level, as shown in modified representation 1222, resulting in a match to file 1202 being found. In this example, the file name is in English but the audio content when rendered is the corresponding spoken phrase in Spanish “una caloría para terminar”.

FIGS. 12C and 12D illustrate an example of matching an internal representation to one or more output data files in an embodiment. In the example shown, the same output files 1200 as in FIG. 12A (shown again in FIG. 12C for convenience and clarity) are matched to the internal representation 1240 of FIG. 12D. In this example, no file name matches the entire top level representation, either with or without the tag “feminine” included. At the second level down, in searching for a file name matching three elements of the representation, file 1206 matching the rightmost three elements is found. Finally, at the bottom (one element) level, files 1204 and 1208 matching the first and second elements, respectively, including meta-information, are found, enabling the Spanish phrase “veintiuna calorías para terminar” to be constructed and rendered as audio output. While in the example shown in FIGS. 12C and 12D separate files match the parts “twenty” and “one (feminine)” to form the contraction “ventiuna”, in other embodiments numbers in the range 21-29 might be recorded separately, and separately for the feminine and masculine case of “21” (i.e., “ventiuna” and ventiuno”, respectively). In such an embodiment, the internal representation “twenty” adjacent to “one_feminine” would match the file for the contraction “twenty one_feminine”, since that would be the largest match, resulting in the translation affording greatest fluency being achieved.

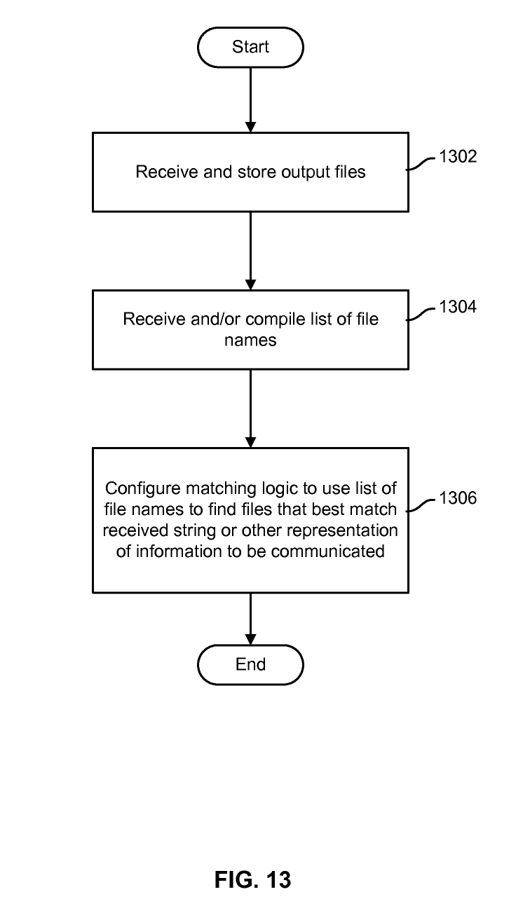

FIG. 13 is a flow diagram illustrating an embodiment of a process to configure a system to communicate information in a target symbolic communication system via a desired medium. In the example shown, output files are received and stored (1302). For example, .aif or other audio files recorded using voice actors to speak words and/or phrases in a target spoken language are received in some embodiments. A list (or other data structure) of file names of the received files is received or generated (1304). A matching logic is configured to use the list of file names to find files that best match a received string or other internal representation of information to be communicated (1306).

While a number of the examples described above involve communicating information in a target spoken language, techniques described herein may be used to communicate information in other target symbolic communication systems. Such other target symbolic communication systems may include, without limitation, translating from an internal representation comprising a string into a displayed written communication in a target font or language, for example using techniques described herein to select font elements to render ligatures comprising two or more adjacent characters properly using a single vector graphic or other file; translating from a string embodying note data into pictures of music notes and/or to render as audible music; and selecting based on an internal string representation tile image files usable to represent two or more different types of terrain, such as to show a land region, a body of water, and a properly rendered coast or other border between them, in one of a plurality of target visual themes or scenarios.

While a number of the examples described above involve audible communication, such as spoken language, techniques described herein may be used to communicate information via other media, such as other sensory perceptible output, including without limitation visual display; multi-media displays; haptic technologies, Braille, or other tactile output; or any other sensory perceptible output used to communicate information according to a symbolic communication system.

Although the foregoing embodiments have been described in some detail for purposes of clarity of understanding, the invention is not limited to the details provided. There are many alternative ways of implementing the invention. The disclosed embodiments are illustrative and not restrictive.

What is claimed is:

1. A method of communicating information, comprising:
receiving an internal representation that expresses an output information in a namespace language used to name a plurality of output files; and
matching the internal representation to one or more of said output files comprising data usable to provide a sensory perceptible output that communicates the output information in a target symbolic communication system.

2. The method of claim 1, wherein the internal representation comprises a string.

3. The method of claim 1, wherein the internal representation comprises a linguistic representation.

4. The method of claim 1, wherein the output information comprises an application output to be rendered to an application user.

5. The method of claim 1, wherein the namespace language comprises a natural language.

6. The method of claim 1, wherein the target symbolic communication system comprises a is natural language

7. The method of claim 1, wherein the target symbolic communication system comprises a language other than the namespace language.

8. The method of claim 1, wherein the output files or other output objects comprise media files.

9. The method of claim 1, wherein the output files or other output objects comprise audio files and the output information is communicated by using a player and one or more audio files matched to the internal representation to provide an audio output that communicates the output information audibly in a target spoken language.

10. A system, comprising:
an interface configured to receive an internal representation that expresses an output information in a namespace language used to name a plurality of output files; and
a processor couple to the interface and configured to matching the internal representation to one or more of said output files comprising data usable to provide a sensory perceptible output that communicates the output information in a target symbolic communication system.

11. The system of claim 10, wherein the internal representation comprises a string.

12. The system of claim 10, wherein the internal representation comprises a linguistic representation.

13. The system of claim 10, wherein the output information comprises an application output to be rendered to an application user.

14. The system of claim 10, wherein the namespace language comprises a natural language.

15. The system of claim 10, wherein the target symbolic communication system comprises a natural language

16. The system of claim 10, wherein the target symbolic communication system comprises a language other than the namespace language.

17. The system of claim 10, wherein the output files or other output objects comprise media files.

18. The system of claim 10, wherein the output files or other output objects comprise audio files and the output information is communicated by using a player and one or more audio files matched to the internal representation to provide an audio output that communicates the output information audibly in a target spoken language.

19. A computer program product for communicating information, the computer program product being embodied in a non-transitory computer readable storage medium and comprising computer instructions for:
receiving an internal representation that expresses an output information in a namespace language used to name a plurality of output files; and
matching the internal representation to one or more of said output files comprising data usable to provide a sensory perceptible output that communicates the output information in a target symbolic communication system.

20. The computer program product of claim 19, wherein the target symbolic communication system comprises a language other than the namespace language.
